(19) United States
(12) Patent Application Publication
(10) Pub. No.: US 2011/0247442 A1
(43) Pub. Date: Oct. 13, 2011

(54) Gear selection device for a vehicle transmission

(76) Inventors: Christopher Charles Trevino, Temecula, CA (US); Stephen Jack McKinley, Lakeside, CA (US)

(21) Appl. No.: 13/066,093

(22) Filed: Apr. 6, 2011

Related U.S. Application Data
(60) Provisional application No. 61/342,095, filed on Apr. 9, 2010.

(51) Int. Cl. F16H 59/04

(52) U.S. Cl. 74/473.3

(57) ABSTRACT

A gear shift device for a vehicle transmission by the hand of the operator which includes a housing having and opening therethrouh. A gear shift lever is mounted within the housing having an upper first end for gripping by the hand of the operator and a bottom second end for coupling to the transmission. A mechanism is mounted in the housing for providing an upper pivot point for the lever for forward and backward movement and a lower pivot point for providing sideways movement for the lever, when moved by the hand of the operator

### RELATED APPLICATIONS

This application is a continuation of the Provisional Application Ser. No. 61/342,095 filed Apr. 9, 2010

### FIELD OF INVENTION

The invention relates to the field of vehicle transmission shifting devices for vehicles, particularly automobile transmissions;

### BACKGROUND OF INVENTION

Since manual transmission shifters were introduced into vehicles there has been a need to decrease shift times for faster and smoother shifts. Some changes were made to help smooth the shifting of manual transmissions, but for the most part the manual shift lever has remained unchanged for quite some time. A trend has come about where individuals want “short throw shifters” to decrease their shift times, by reducing the distance the shift lever needs to travel to get into and out of gear.

One of the most common shifters is a simple shaft with a shift handle on one end of a ball fitting and a short shaft extending from other end of the ball fitting that connects to the transmission shaft. By moving the ball fitting further away from the transmission shaft shorter movement by the driver is required, but shifting forces are increased. Such shifters are available from B&M Racing & Performance Products, Chatsworth, Calif. Another type of shifter is a pin and spring type shifter. This type of shifter have single rod shat has springs which bias the rod toward a center position. Thus moving forward and backwards is conventional, but sideways movement is biased to the center position. Such shifters are available from B&M Racing & Performance Products, 9142 Independence Ave, Chatsworth, Calif. 91311. The most common problem with these conventional short throw shifters is that they reduce, by the same ratio, the entire shift pattern, both into and out of gear, as well as left to right movements for selecting different shift gates. These short shifters are difficult to use, as it is easy to accidentally bypass gears when shifting, due to the reduced distance left to right. It is common to accidentally shift from 2^{nd} gear to 5^{th} gear with conventional short throw shifters. Thus what is need is a shifter that shorts the shift pattern into and out of gear, but maintains a close to factory left to right motion so transitional gears are easily selected, and is also still is easy to shift.

Thus it is a primary purpose of the invention to provide an improved gear selection devise.

It is another purpose of the invention to provide an improved gear selection devise that shortens the movement required to shift the transmission into and out of gear, while maintaining a close to factory left to right motion, thus limiting the possibility of accidentally shifting to an undesired gear. This eliminates a very common problem in the industry, as short throw shifters require you to be very careful when transitioning between shift rails when shifting.

It is an additional purpose of the invention to provide an improved gear selection devise that can easily replace an existing gear selection devise in a vehicle such as an automobile with one that provides short shift motion.

### SUMMARY OF THE INVENTION

The invention is a gear selection device for a vehicle such as an automobile, which provides shorter shift motion into and out of gear by the operator of the vehicle, while maintaining a close to factory left to right shift motion. In detail, the device includes a hollow housing for mounting the devise in the vehicle. The housing further includes first and second holes in the walls in alignment with each other. A first rod having first and second ends is mounted by the ends thereof in the first and second holes in the walls. A bracket is rotatably mounted to the first rod and includes a second rod mounted therein at 90 degrees to the first rod.

A gear shift lever includes a griping handle at a first end and means to attach to the transmission shifting rod at the second end. The gear shift lever further includes a slot though which the first rod extends therethrough and a hole at 90 degrees to the slot through which the second rod extends therethrough. Thus the gear shift lever can rotate about the second rod in forward and backward direction and about the second rod in directions 90 degrees to the first direction. This provides a shorter shift motion than is available from the prior art devices, with less force required, and maintaining a close to factory left to right motion while shifting.

In addition, where the existing shifting device has a shifting lever that terminates in a ball fitting that is connected directly to the transmission, the second end of the lever can terminate in a ball fitting. Thus it can be directly substituted.

The novel features which are believed to be characteristic of the invention, both as to its organization and method of operation, together with further objects and advantages thereof, will be better understood from the following description in connection with the accompanying drawings in which the presently preferred embodiments of the invention are illustrated by way of examples. It is to be expressly understood, however, that the drawings are for purposes of illustration and description only and are not intended as a definition of the limits of the invention.

### BRIEF DESCRIPTION OF DRAWINGS

FIG. 1 is a partial side view of the interior of an automobile illustrating the connection of the subject devise to the transmission operating rod.

FIG. 2 is a top view of the device partially broken away to show the interior thereof.

FIG. 3 is a cross-sectional view of FIG. 2 taken along the line 3-3.

FIG. 4 is a cross-sectional view of FIG. 2 taken along the line 4-4.

FIGS. 5A, 5B and 5C are pictorial representations of three shift patterns: a convention stroke pattern, an after market short shift pattern and the subject device shift pattern.

FIG. 6 is a side view of a second embodiment using socket and ball connection to the transmission.

### DESCRIPTION OF THE PREFERRED EMBODIMENT

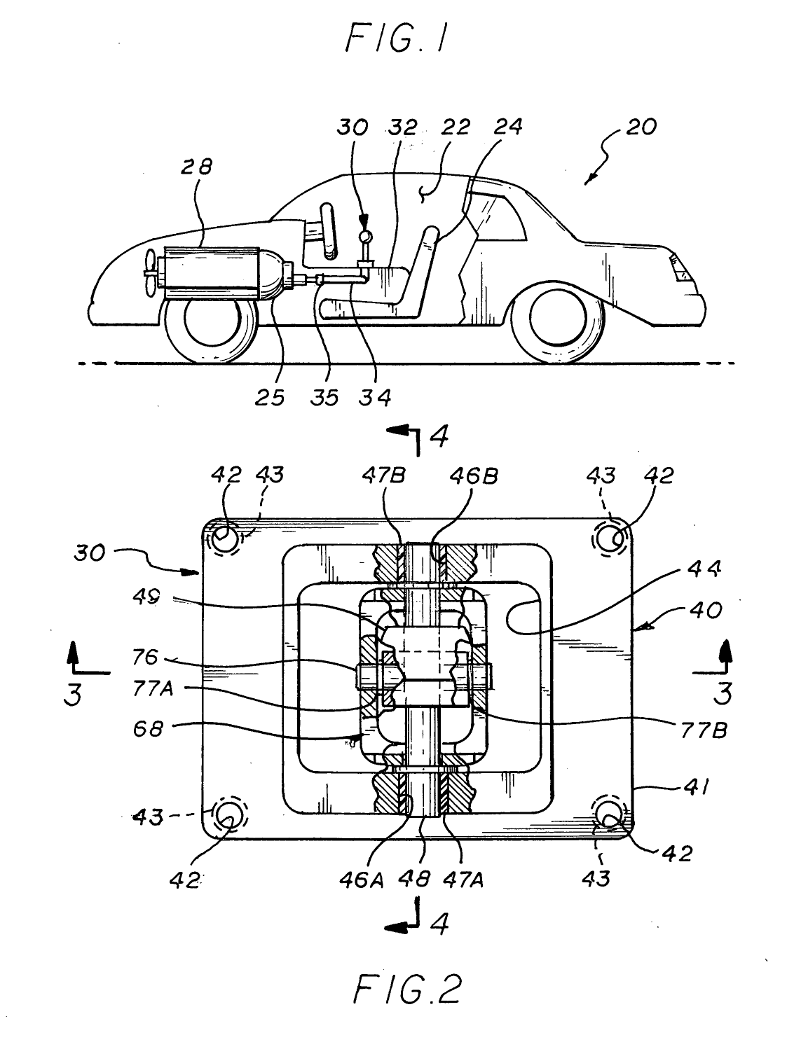

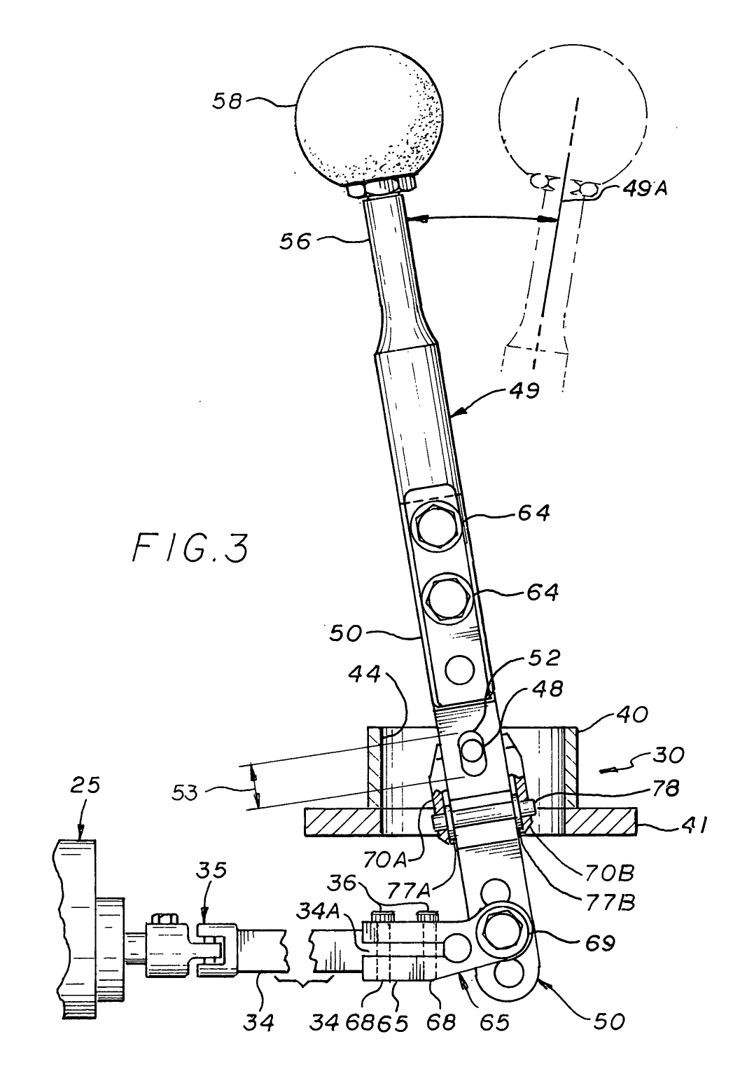

Referring to FIGS. 1 and 3 which is a partial side view of an automobile, which is a generally designated by numeral 20, which includes a passenger compartment 22 having seats 24. The automobile further includes a transmission 25 coupled to an engine 28. The subject devise 30 is mounted on the transmission cover 32 and coupled to the transmission actuating rod 34 with a universal joint 35, which will be subsequently described in further detail.

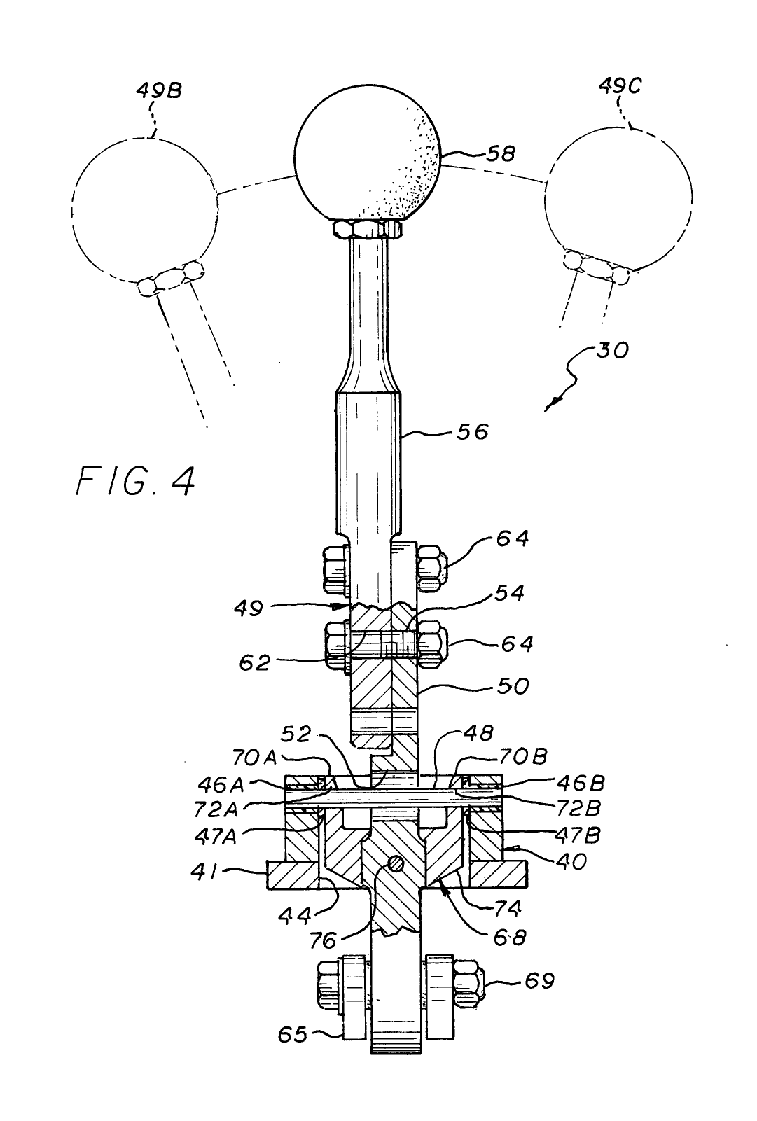

Referring to FIGS. 1-6, the device 30 includes a housing 40, having a mounting flange 41 with fastener holes 42 for fasteners 43 that mount the device 30 to the cover 32 and an opening 44 therethrough. The housing includes aligned holes 46A and 46B in which are bushings 47A and 47B mounting a rod 48. A lever 49 includes a portion 50 having a slot 52 with a length 53 engaged with the rod 48. End 55 of portion 50 includes holes 54 extending therethrough. A griping handle 56 includes a griping ball 58 and a shaft 60 having holes 62 (only one is shown). The handle 56 is attached to the portion 50 by fastener assemblies 64. The portion 50 extends through the opening 44 terminates in a clevis member 65 rotatably attached by bolt 66. The clevic member 65 connects to the necked down end 34A of the actuating rod 34 by fastener assemblies 68.

A bracket 68, having arms 70A and 70B that straddle portion 50 of the lever 49, is rotatably mounted to the rod 48 The rod 48 passes through holes 72A and 72B in the arms 70A and 70B. The end 74 of the bracket 68 mounts a second rod 76 through, which extends through a hole 78 in the portion 50 of the lever 49. Spacers 77A and 77B eliminates any play between the lever 49 and bracket 68

Thus the lever 49 can be rotated forward and backward to position 49A about rod 48 so that the actuating rod 34 moves toward and away from the transmission causing up shifts or down shifts (for example from first gear to second gear) or from side to side about the rod 76, which is required to shift from second to third, etc. The lever 49 can also be moved from position 49 to positions 49B and 49C, to rotate the rod 34, while the transmission is in neutral. Note that the length 53 of the slot 52 is sufficient to allow the rotation of the lever 49 to rotate the actuating rod 34 so that shifts can be accomplished. Furthermore, there is a universal joint 35 on actuating rod 34 which allows rotation of the rod 34 without translation thereof.

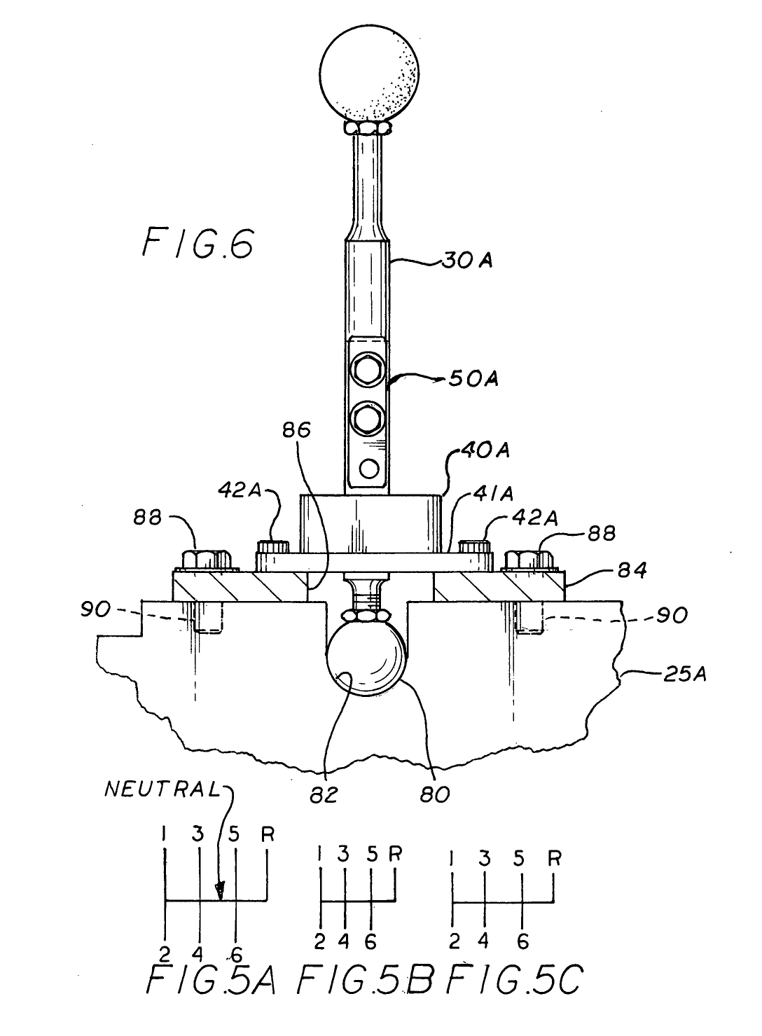

Referring to FIGS. 5A, 5B and 5C, the shift pattern 5A of the conventional shifting device is larger than the prior art aftermarket shifting device. While the subject device depicted in FIG. 5C is in between. Thus the movement form first gear to second gear is essentially identical with the prior art device shown in FIG. 5B, (ball fitting connection with spring biasing); however it requires a slightly larger sideways motion from going from second gear to third, etc but lower forward and backward motion is required.

A second embodiment is illustrated in FIG. 6. The device, generally indicated by numeral 30A is identical to the device 30 except the portion 50A of the lever 49A terminates in a ball 80 that mates directly with the ball socket 82 in the transmission 25A. Ball socket connections are found in many manual transmissions in automobiles. An adapter plate 84 is positioned over the opening 86 where the original shifter mated to the transmission 25A and is bolted in place by fasteners 88 which mate with threaded holes 90 in the transmission. The flange 41A of the housing 40A is then bolted to the adapter plate 84 by fasteners 42A with the ball 80 extending through the opening 84 and is engaged with the socket 82.

The novel features which are believed to be characteristic of the invention, both as to its organization and method of operation, together with further objects and advantages thereof, will be better understood from the following description in connection with the accompanying drawings in which the presently preferred embodiments of the invention are illustrated by way of examples. It is to be expressly understood, however, that the drawings are for purposes of illustration and description only and are not intended as a definition of the limits of the invention.

1. A gear shift devise for shifting a transmission having a shifting connection fitting to the transmission, the device comprising:
a hollow housing having first and second holes in the wall thereof aligned with each other;
a first rod having first and second ends mounted in said first and second holes, respectively, in said walls of said housing;
a bracket rotatably mounted to said first rod, said bracket having a second rod mounted therein at 90 degrees to said first rod;
a gear shift lever having first end adapted for griping by a hand and a second end adapted to mate with the connection fitting of the transmission, said lever having a slot located between said first and second ends through which said first rod extends therethrough, and a hole therethrough 90 degrees to said slot through which said second rod extends therethrough; and
such that said gear shift lever can rotate about said second rod in a first direction and rotate about said first rod in a direction 90 degrees to the first direction.

2. The gear shift device as set forth in claim 1 wherein the length of said slot in said lever is sufficiently long as to allow said lever to rotate about said second rod a distance sufficient to allow the transmission to be shifted.

3. The gear shift device of as set forth in claim 2 where in the hollow housing is large enough to allow the bracket and lever to rotate a sufficient distance to allow the transmission to be shifted.

4. A gear shift device for a vehicle transmission by the hand of the operator comprising:
a housing having and opening therethrouh;
a gear shift lever mounted within said housing having an upper first end for gripping by the hand of the operator and a bottom second end for coupling to the transmission; and
means mounted in said housing for providing an upper pivot point for the lever for forward and backward movement and a lower pivot point for providing sideways movement for the lever, when moved by the hand of the operator.

5. The device as set forth in claim 4 wherein said means comprise;
a first rod having first and second ends mounted in said first and second holes, respectively, in said walls of said housing;
a bracket rotatably mounted to said first rod, said bracket having a second rod mounted therein at 90 degrees to said first rod; and
said gear shift lever having a slot located between said upper and lower ends through which said first rod extends therethrough, and a hole therethrough 90 degrees to said slot through which said second rod extends therethrough;

6. The gear shift device as set forth in claim 5 wherein the length of said slot in said lever is sufficiently long as to allow said lever to rotate about said second rod a distance sufficient to allow said lever to move sideways so that the transmission to be shifted.

7. The gear shift device of as set forth in claim 6 where in the hollow housing is large enough to allow the bracket and lever to rotate forward and backwards a sufficient distance to allow the transmission to be shifted
